(19) United States
(12) Patent Application Publication
(10) Pub. No.: US 2015/0337109 A1
(43) Pub. Date: Nov. 26, 2015

(54) TIRE COMPRISING A RUBBER COMPOSITION COMPRISING AN EPOXIDE ELASTOMER CROSSLINKED WITH A POLYCARBOXYLIC ACID

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: ETIENNE FLEURY, Clermont-Ferrand (FR); BENOIT SCHNELL, Clermont-Ferrand (FR)

(21) Appl. No.: 14/652,899

(22) PCT Filed: Dec. 12, 2013
(86) PCT No.: PCT/EP2013/076417

§ 371 Date: Jun. 17, 2015

(30) Foreign Application Priority Data
Dec. 17, 2012 (FR) 1262162

(51) Int. Cl. C08K 3/36; C08K 3/04

(52) U.S. Cl. CPC C08K 3/36; C08K 3/04

(57) ABSTRACT

A tire comprises a rubber composition based on at least one predominant diene elastomer comprising epoxide functional groups, at least one reinforcing filler, and a crosslinking system. The crosslinking system comprises a polycarboxylic acid of general formula (I):

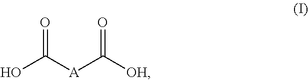

in which A represents a covalent bond or a hydrocarbon group which comprises at least 1 carbon atom, which is optionally substituted and which is optionally interrupted by one or more heteroatoms, and an imidazole of general formula (II):

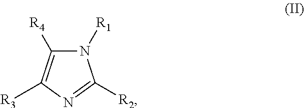

in which R₁ represents a hydrocarbon group or a hydrogen atom, R₂ represents a hydrocarbon group, R₃ and R₄ represent, independently of one another, a hydrogen atom or a hydrocarbon group, or else R₃ and R₄ form, together with the carbon atoms of the imidazole ring to which they are attached, a ring.

The present invention relates to tyres provided with rubber compositions, in particular with rubber compositions based on elastomers comprising epoxide functional groups.

Since fuel savings and the need to protect the environment have become a priority, it has proved necessary to produce tyres having a rolling resistance which is as low as possible. This has been made possible in particular by virtue of the use, in rubber compositions, of specific inorganic fillers capable of rivalling, from the reinforcing viewpoint, an organic filler, such as a conventional tyre-grade carbon black, while offering these compositions a lower hysteresis, which is synonymous with a lower rolling resistance for the tyres comprising them.

To further reduce the rolling resistance remains, in the current economic and ecological context, an ongoing concern despite the low levels respectively achieved both with specific inorganic fillers described as “reinforcing” and with a carbon black. Many avenues have already been explored in order to further lower the hysteresis of the rubber compositions reinforced with such reinforcing fillers. Nevertheless, it still remains advantageous to pursue an objective of lowering the consumption of the vehicles, which lowering can result from an improvement in the hysteresis properties of the tyre compositions.

Furthermore, it is known, and has been normal for a great many years, to use, in tyres, rubber compositions having an elastomer matrix which is crosslinked with sulphur; this crosslinking is then known as vulcanization. The conventional vulcanization system combines molecular sulphur and at least one vulcanization accelerator. However, it is known that such a system is damaging to the processing of the composition before curing by the scorching phenomenon. It should be remembered that the “scorching” phenomenon rapidly results, during the preparation of the rubber compositions, in premature vulcanizations (“scorching”), in very high viscosities in the raw state, and ultimately in rubber compositions which are virtually impossible to work and to process industrially.

Consequently, the vulcanization systems have been improved over the years, in combination with the processes for the preparation of the rubber compositions, in order to overcome the abovementioned disadvantages. Thus, the compositions are often complex and comprise, in addition to the molecular sulphur or an agent which donates molecular sulphur, vulcanization accelerators, activators and optionally vulcanization retardants. At present, it would be advantageous for manufacturers to find crosslinking systems which are as effective as vulcanization, while simplifying the compositions and their preparation.

On continuing their research studies, the Applicant Companies have now found that specific compositions for tyres can be prepared in a simplified manner, with respect to the conventionally vulcanized compositions, and that these compositions can exhibit improved hysteresis properties.

Consequently, a first subject-matter of the invention is a tyre comprising a rubber composition based on at least one predominant diene elastomer comprising epoxide functional groups, at least one reinforcing filler and a crosslinking system comprising a polycarboxylic acid of general formula (I):

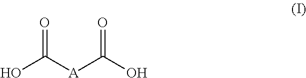

in which A represents a covalent bond or a hydrocarbon group which comprises at least 1 carbon atom, which is optionally substituted and which is optionally interrupted by one or more heteroatoms, and an imidazole of general formula (II):

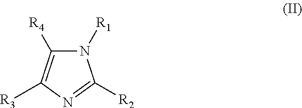

in which:

R₁ represents a hydrocarbon group or a hydrogen atom,

R₂ represents a hydrocarbon group,

R₃ and R₄ represent, independently of one another, a hydrogen atom or a hydrocarbon group,

or else R₃ and R₄ form, together with the carbon atoms of the imidazole ring to which they are attached, a ring.

Preferably, a subject-matter of the invention is a tyre as defined above in which A represents a covalent bond or a divalent hydrocarbon group comprising from 1 to 1800 carbon atoms and preferably from 2 to 300 carbon atoms. More preferably, A represents a divalent hydrocarbon group comprising from 2 to 100 carbon atoms and preferably from 2 to 50 carbon atoms. More preferably still, A represents a divalent hydrocarbon group comprising from 3 to 500 carbon atoms and preferably from 5 to 50 carbon atoms. More preferably still, A represents a divalent hydrocarbon group comprising from 8 to 50 carbon atoms and preferably from 10 to 40 carbon atoms.

Preferably again, a subject-matter of the invention is a tyre as defined above in which A is a divalent group of aliphatic or aromatic type or a group comprising at least an aliphatic portion and an aromatic portion. Preferably, A is a divalent group of aliphatic type or a group comprising at least an aliphatic portion and an aromatic portion. Preferably again, A is a divalent group of saturated or unsaturated aliphatic type. Very preferably, A is an alkylene group.

Preferably, a subject-matter of the invention is a tyre as defined above in which A is interrupted by at least one heteroatom chosen from oxygen, nitrogen and sulphur, preferably oxygen.

Preferably again, a subject-matter of the invention is a tyre as defined above in which

A is substituted by at least one radical chosen from alkyl, cycloalkylalkyl, aryl, aralkyl, hydroxyl, alkoxy, amino and carbonyl radicals. Preferably, A is substituted by one or more carboxylic acid functional groups and/or by one or more hydrocarbon radicals chosen from alkyl, cycloalkyl, cycloalkylalkyl, aryl or aralkyl radicals, themselves substituted by one or more carboxylic acid functional groups. Alternatively and preferably again, A does not comprise another carboxylic acid functional group.

Preferably, a subject-matter of the invention is a tyre as defined above in which the content of polyacid is within a range extending from 0.2 to 100 phr and preferably from 0.2 to 50 phr. More preferably, the content of polyacid is within a range extending from 0.4 to 27 phr and preferably from 0.9 to 20 phr.

Preferably, a subject-matter of the invention is a tyre as defined above in which:
R₁ represents a hydrogen atom or an alkyl group having from 1 to 20 carbon atoms, a cycloalkyl group having from 5 to 24 carbon atoms, an aryl group having from 6 to 30 carbon atoms or an aralkyl group having from 7 to 25 carbon atoms, which group can optionally be interrupted by one or more heteroatoms and/or substituted,
R₂ represents an alkyl group having from 1 to 20 carbon atoms, a cycloalkyl group having from 5 to 24 carbon atoms, an aryl group having from 6 to 30 carbon atoms or an aralkyl group having from 7 to 25 carbon atoms, which group can optionally be interrupted by one or more heteroatoms and/or substituted,
R₃ and R₄ independently represent identical or different groups chosen from hydrogen or alkyl groups having from 1 to 20 carbon atoms, cycloalkyl groups having from 5 to 24 carbon atoms, aryl groups having from 6 to 30 carbon atoms or aralkyl groups having from 7 to 25 carbon atoms, which groups can optionally be interrupted by heteroatoms and/or substituted, or else R₃ and R₄ form, together with the carbon atoms of the imidazole ring to which they are attached, a ring chosen from aromatic, heteroaromatic or aliphatic rings comprising from 5 to 12 carbon atoms, preferably 5 or 6 carbon atoms.

Preferably, a subject-matter of the invention is a tyre as defined above in which R₁ represents a group chosen from alkyl groups having from 2 to 12 carbon atoms or aralkyl groups having from 7 to 13 carbon atoms, which groups can optionally be substituted.

Preferably again, a subject-matter of the invention is a tyre as defined above in which R₁ represents an optionally substituted aralkyl group having from 7 to 13 carbon atoms and R₂ represents an alkyl group having from 1 to 12 carbon atoms. More preferably, R₁ represents an optionally substituted aralkyl group having from 7 to 9 carbon atoms and R₂ represents an alkyl group having from 1 to 4 carbon atoms.

Preferably, a subject-matter of the invention is a tyre as defined above in which R₃ and R₄ independently represent identical or different groups chosen from hydrogen or alkyl groups having from 1 to 12 carbon atoms, cycloalkyl groups having from 5 to 8 carbon atoms, aryl groups having from 6 to 24 carbon atoms or aralkyl groups having from 7 to 13 carbon atoms, which groups can optionally be substituted.

Preferably again, a subject-matter of the invention is a tyre as defined above in which R₃ and R₄ form, with the carbon atoms of the imidazole ring to which they are attached, a benzene, cyclohexene or cyclopentene ring.

Preferably, a subject-matter of the invention is a tyre as defined above in which the imidazole content is within a range extending from 0.5 to 4 molar equivalents and preferably from 0.5 to 3 molar equivalents, with respect to the carboxylic acid functional groups present on the polycarboxylic acid of general formula (I). More preferably, the imidazole content is within a range extending from 0.5 to 2.5 molar equivalents, preferably from 0.5 to 2 molar equivalents and more preferably still from 0.5 to 1.5 molar equivalents, with respect to the carboxylic acid functional groups present on the polycarboxylic acid of general formula (I).

Preferably, a subject-matter of the invention is a tyre as defined above in which the predominant diene elastomer comprising epoxide functional groups is an epoxidized diene elastomer chosen from the group consisting of epoxidized natural rubbers, epoxidized synthetic polyisoprenes and the mixtures of these.

Preferably, a subject-matter of the invention is a tyre as defined above in which the predominant diene elastomer comprising epoxide functional groups represents from 30 to 100 phr, preferably from 50 to 100 phr, as a blend with from 0 to 70 phr, preferably from 0 to 50 phr, of one or more minor non-epoxidized elastomers. More preferably, the predominant diene elastomer comprising epoxide functional groups represents all of the 100 phr of elastomer.

Preferably, a subject-matter of the invention is a tyre as defined above in which the reinforcing filler comprises carbon black, silica or a mixture of carbon black and silica. Preferably, a subject-matter of the invention is a tyre as defined above in which the content of reinforcing filler is between 20 and 200 phr.

The tyres in accordance with the invention are intended in particular for passenger vehicles as well as two-wheel vehicles (motorcycles, bicycles), industrial vehicles chosen from vans, “heavy-duty” vehicles—i.e. underground, bus, heavy road transport vehicles (lorries, tractors, trailers), off-road vehicles, heavy agricultural vehicles or earthmoving equipment, aircraft, and other transportation or handling vehicles.

The invention and its advantages will be easily understood in the light of the description and implementational examples which follow.

I. Tests

The rubber compositions are characterized, after curing, as indicated below.

I.1. Tensile tests

These tensile tests make it possible to determine the elasticity stresses and the properties at break. Unless otherwise indicated, they are carried out in accordance with French Standard NF T 46-002 of September 1988. Processing the tensile recordings also makes it possible to plot the curve of modulus as a function of the elongation, the modulus used here being the nominal (or apparent) secant modulus measured in first elongation, calculated by reducing to the initial cross-section of the test specimen. The nominal secant moduli (or apparent stresses, in MPa) are measured in first elongation at 50% and 100% elongation, respectively denoted MSA50 and MSA100.

The breaking stresses (in MPa) and the elongations at break (in %) are measured at 23° C. ±2° C. according to Standard NF T 46-002.

I.2. Dynamic Properties

The dynamic properties are measured on a viscosity analyser (Metravib VA4000) according to Standard ASTM D 5992-96. The response of a sample of crosslinked composition (cylindrical test specimen with a thickness of 4 mm and a cross-section of 400 mm²), subjected to a simple alternating sinusoidal shear stress, at a frequency of 10 Hz, under standard temperature conditions (23° C.) according to Standard ASTM D 1349-99 or, as the case may be, at a different temperature, is recorded. A strain amplitude sweep is carried out from 0.1% to 100% (outward cycle) and then from 100% to 0.1% (return cycle). The result made use of is the loss factor tan(δ). For the return cycle, the maximum tan(δ) value observed, denoted tan(δ)max at 23° C., is shown.

It should be remembered that, in a way well-known to a person skilled in the art, the value of tan(δ)max at 23° C. is representative of the hysteresis of the material and thus of the rolling resistance: the lower tan(δ)max at 23° C., the more the rolling resistance is reduced.

II. Composition of the Tyres of the Invention

The tyre according to the invention comprises a rubber composition based on at least one elastomer comprising epoxide functional groups, at least one reinforcing filler and a crosslinking system comprising a polycarboxylic acid of general formula (I) and an imidazole of general formula (II).

The expression composition “based on” should be understood as meaning a composition comprising the mixture and/or the reaction product of the various constituents used, some of these base constituents being capable of reacting or intended to react with one another, at least in part, during the various phases of manufacture of the composition, in particular during the crosslinking or vulcanization thereof.

The expression “molar equivalent”, which is well-known to a person skilled in the art, should be understood as meaning the quotient of the number of moles of the compound concerned to the number of moles of the reference compound. Thus, 2 equivalents of a compound B with respect to a compound A represent 2 mol of the compound B when 1 mol of the compound A is used.

When reference is made to a “predominant” compound, this is understood to mean, within the meaning of the present invention, that this compound is predominant among the compounds of the same type in the composition, that is to say that it is the one which represents the greatest amount by weight among the compounds of the same type. Thus, for example, a predominant elastomer is the elastomer representing the greatest weight with respect to the total weight of the elastomers in the composition. In the same way, a “predominant” filler is that representing the greatest weight among the fillers of the composition. By way of example, in a system comprising just one elastomer, the latter is predominant within the meaning of the present invention and, in a system comprising two elastomers, the predominant elastomer represents more than half of the weight of the elastomers.

On the contrary, a “minor” compound is a compound which does not represent the greatest fraction by weight among the compounds of the same type.

In the present description, unless expressly indicated otherwise, all the percentages (%) shown are percentages (%) by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

II. 1.1. Diene Elastomer Comprising Epoxide Functional Groups (or epoxidized diene elastomer)

It should be remembered that elastomer or rubber (the two terms being in a known way synonymous and interchangeable) of the epoxidized diene type should be understood as meaning an elastomer which results at least in part (i.e., a homopolymer or a copolymer) from diene monomers (monomers bearing two conjugated or non-conjugated carbon-carbon double bonds) and which is functionalized, that is to say that it bears epoxide functional groups.

A first characteristic of the epoxidized diene elastomers is thus that of being diene elastomers. These diene elastomers, in the present patent application by definition non-thermoplastic, exhibiting a Tg which in the very great majority of cases is negative (that is to say, less than 0° C.), can be categorized in a known way into two categories: those referred to as “essentially unsaturated” and those referred to as “essentially saturated”. Butyl rubbers, such as, for example, copolymers of dienes and of a-olefins of EPDM type, come within the category of essentially saturated diene elastomers, having a content of units of diene origin which is low or very low, always less than 15% (mol %). In contrast, essentially unsaturated diene elastomer is understood to mean a diene elastomer resulting at least in part from conjugated diene monomers, having a content of units of diene origin (conjugated dienes) which is greater than 15% (mol %). In the category of “essentially unsaturated” diene elastomers, “highly unsaturated” diene elastomer is understood to mean in particular a diene elastomer having a content of units of diene origin (conjugated dienes) which is greater than 50%.

It is preferable to use at least one diene elastomer of the highly unsaturated type, in particular a diene elastomer selected from the group consisting of natural rubber (NR), synthetic polyisoprenes (IRs), polybutadienes (BRs), butadiene copolymers, isoprene copolymers and the mixtures of these elastomers. Such copolymers are more preferably selected from the group consisting of butadiene/styrene copolymers (SBRs), isoprene/butadiene copolymers (BIRs), isoprene/styrene copolymers (SIRs), isoprene/butadiene/styrene copolymers (SBIRs) and the mixtures of such copolymers.

The above diene elastomers can, for example, be block, statistical, sequential or microsequential elastomers and can be prepared in dispersion or in solution; they can be coupled and/or star-branched or else functionalized with a coupling and/or star-branching or functionalization agent.

The following are preferably suitable: polybutadienes and in particular those having a content of 1,2- units of between 4% and 80% or those having a content of cis-1,4-units of greater than 80%, polyisoprenes, butadiene/styrene copolymers and in particular those having a styrene content of between 5% and 50% by weight and more particularly between 20% and 40%, a content of 1,2-bonds of the butadiene part of between 4% and 65% and a content of trans-1,4- bonds of between 20% and 80%, butadiene/isoprene copolymers and in particular those having an isoprene content of between 5% and 90% by weight and a glass transition temperature from −40° C. to −80° C., or isoprene/styrene copolymers and in particular those having a styrene content of between 5% and 50% by weight and a Tg of between −25° C. and −50° C.

In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content of 1,2- units of the butadiene part of between 4% and 85%, a content of trans-1,4-units of the butadiene part of between 6% and 80%, a content of 1,2-plus 3,4-units of the isoprene part of between 5% and 70% and a content of trans-1,4-units of the isoprene part of between 10% and 50%, and more generally any butadiene/styrene/isoprene copolymer having a Tg of between −20° C. and 70° C., are suitable in particular.

The Tg of the thermoplastic polymers and of the diene elastomers described above is measured in a known way by DSC (Differential Scanning Calorimetry), for example, and unless specifically indicated otherwise in the present patent application, according to Standard ASTM D3418 of 1999.

A second essential characteristic of the epoxidized diene elastomer of use for the requirements of the invention is that it is functionalized, bearing epoxide functional groups.

Such epoxidized diene elastomers and their processes of preparation are well-known to a person skilled in the art and are commercially available. Diene elastomers bearing epoxide groups have been described, for example, in US 2003/120007 or EP 0 763 564, and U.S. Pat. No. 6,903,165 or EP 1 403 287.

Preferably, the epoxidized diene elastomer is selected from the group consisting of epoxidized natural rubbers (NRs) (abbreviated to “ENRs”), epoxidized synthetic polyisoprenes (IRs), epoxidized polybutadienes (BRs) preferably having a content of cis-1,4-bonds of greater than 90%, epoxidized butadiene/styrene copolymers (SBRs) and the mixtures of these elastomers.

Epoxidized natural rubbers (abbreviated to “ENRs”), for example, can be obtained in a known way by epoxidation of natural rubber, for example by processes based on chlorohydrin or on bromohydrin or processes based on hydrogen peroxides, on alkyl hydroperoxides or on peracids (such as peracetic acid or performic acid); such ENRs are, for example, sold under the names “ENR-25” and “ENR-50” (respective degrees of epoxidation of 25% and 50%) by Guthrie Polymer. Epoxidized BRs are themselves also well-known, for example sold by Sartomer under the name “Poly Bd” (for example, “Poly Bd 605E”). Epoxidized SBRs can be prepared by epoxidation techniques well-known to a person skilled in the art.

The degree (mol %) of epoxidation of the epoxidized diene elastomers described above can vary to a great extent according to the specific embodiments of the invention, preferably within a range from 0.2% to 80%, preferably within a range from 2% to 50% and more preferably within a range from 2.5% to 30%. When the degree of epoxidation is less than 0.2%, there is a risk of the targeted technical effect being insufficient whereas, above 80%, the molecular weight of the polymer greatly decreases. For all these reasons, the degree of functionalization, in particular of epoxidation, is more preferably within a range from 2.5% to 30%.

The epoxidized diene elastomers described above are in a known way solid at ambient temperature (20° C.); solid is understood to mean any substance not having the ability to eventually assume, at the latest after 24 hours, solely under the effect of gravity and at ambient temperature (20° C.), the shape of the container in which it is present. The rubber composition according to the invention comprises a diene elastomer.

The compositions of the tyres of the invention can comprise just one epoxidized diene elastomer or a mixture of several epoxidized diene elastomers (which will then be denoted in the singular as being “epoxidized diene elastomer” in order to represent the sum of the epoxidized elastomers of the composition), it being possible for the epoxidized diene elastomer to be used in combination with any type of non-epoxidized elastomer, for example diene elastomer, indeed even with elastomers other than diene elastomers.

The epoxidized diene elastomer is predominant in the rubber composition of the tyre of the invention, that is to say that it is either the only elastomer (or the only elastomers, if the elastomers are a mixture of epoxidized diene elastomers) or it is that which represents the greatest weight among the elastomers of the composition.

Preferably, the predominant diene elastomer is selected from the group consisting of epoxidized natural rubbers, epoxidized synthetic polyisoprenes and the mixtures of these.

According to a preferred embodiment of the invention, the rubber composition comprises, for example, from 30 to 100 phr, in particular from 50 to 100 phr, of a predominant epoxidized diene elastomer as a blend with from 0 to 70 phr, in particular from 0 to 50 phr, of one or more minor non-epoxidized elastomers.

According to another preferred embodiment of the invention, the composition comprises, for the whole of the 100 phr of elastomer, one or more epoxidized diene elastomers.

II.2. Reinforcing Filler

Use may be made of any type of reinforcing filler known for its abilities to reinforce a rubber composition which can be used for the manufacture of tyres, for example an organic filler, such as carbon black, a reinforcing inorganic filler, such as silica, or also a blend of these two types of filler, in particular a blend of carbon black and silica.

All carbon blacks, in particular blacks of the HAF, ISAF or SAF type, conventionally used in tyres (“tyre-grade” blacks), are suitable as carbon blacks. Mention will more particularly be made, among the latter, of the reinforcing carbon blacks of the 100, 200 or 300 series (ASTM grades), such as, for example, the N115.

N134, N234, N326, N330, N339, N347 or N375 blacks, or also, according to the targeted applications, of the blacks of higher series (for example, N660, N683 or N772). The carbon blacks might, for example, be already incorporated in an isoprene elastomer in the form of a masterbatch (see, for example, Application WO 97/36724 or WO 99/16600).

Mention may be made, as examples of organic fillers other than carbon blacks, of functionalized polyvinyl organic fillers, such as described in Applications WO-A-2006/069792, WO-A-2006/069793, WO-A-2008/003434 and WO-A-2008/003435.

“Reinforcing inorganic filler” should be understood, in the present patent application, by definition, as meaning any inorganic or mineral filler (whatever its colour and its origin, natural or synthetic), also known as “white filler”, “clear filler” or indeed even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state under which the reinforcing inorganic filler is provided is not important, whether it is in the form of a powder, of microbeads, of granules, of beads or any other appropriate densified form. Of course, reinforcing inorganic filler is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface and a CTAB specific surface which are both less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in Application WO 03/16837.

The reinforcing inorganic filler used, in particular if it is silica, preferably has a BET specific surface of between 45 and 400 m²/g, more preferably of between 60 and 300 m²/g.

Preferably, the content of total reinforcing filler (carbon black and/or reinforcing inorganic filler, such as silica) is between 20 and 200 phr, more preferably between 30 and 150 phr, the optimum being, in a known way, different depending on the specific applications targeted: the level of reinforcement expected with regard to a bicycle tyre, for example, is, of course, less than that required with regard to a tyre capable of running at high speed in a sustained manner, for example a motorcycle tyre, a tyre for a passenger vehicle or a tyre for a utility vehicle, such as a heavy-duty vehicle.

According to a preferred embodiment of the invention, use is made of a reinforcing filler comprising between 30 and 150 phr, more preferably between 50 and 120 phr, of organic filler, particularly of carbon black, and optionally silica; the silica, when it is present, is preferably used at a content of less than 20 phr, more preferably of less than 10 phr (for example between 0.1 and 10 phr). This preferred embodiment is particularly preferred when the predominant elastomer of the composition is an epoxidized isoprene rubber, more particularly epoxidized natural rubber.

Alternatively, according to another preferred embodiment of the invention, use is made of a reinforcing filler comprising between 30 and 150 phr, more preferably between 50 and 120 phr, of inorganic filler, particularly of silica, and optionally carbon black; the carbon black, when it is present, is preferably used at a content of less than 20 phr, more preferably of less than 10 phr (for example between 0.1 and 10 phr). This preferred embodiment is also particularly preferred when the predominant elastomer of the composition is an epoxidized isoprene rubber, more particularly epoxidized natural rubber.

Use may be made, in a known way, in order to couple the reinforcing inorganic filler to the diene elastomer, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Use may be made in particular of silane polysulphides, referred to as “symmetrical” or “unsymmetrical” depending on their specific structure, such as described, for example, in Applications WO 03/002648 (or US 2005/016651) and WO 03/002649 (or US 2005/016650).

Suitable in particular, without the definition below being limiting, are silane polysulphides referred to as “symmetrical”, corresponding to the following general formula (I):

### (I)

Z−A−Sₓ−A−Z,

in which:

x is an integer from 2 to 8 (preferably from 2 to 5);

A is a divalent hydrocarbon radical (preferably C₁-0₁₈ alkylene groups or C₆-C₁₂ arylene groups, more particularly C₁-C₁₀ alkylenes, in particular C₁-C₄ alkylenes, especially propylene);

Z corresponds to one of the formulae below:

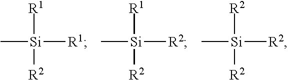

in which:

the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);

the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-0₈ cycloalkoxyls, more preferably still a group chosen from C₁-C₄ alkoxyls, in particular methoxyl and ethoxyl).

In the case of a mixture of alkoxysilane polysulphides corresponding to the above formula (I), in particular normal commercially available mixtures, the mean value of the “x” indices is a fractional number preferably of between 2 and 5, more preferably of approximately 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, such as described in Patent Application WO 02/083782 (or US 2004/132880).

Mention will in particular be made, as coupling agents other than an alkoxysilane polysulphide, of bifunctional POSs (polyorganosiloxanes) or else of hydroxysilane polysulphides (R² =OH in the above formula I), such as described in Patent Applications WO 02/30939 (or U.S. Pat. No. 6,774,255) and WO 02/31041 (or US 2004/051210), or else of silanes or POSs bearing azodicarbonyl functional groups, such as described, for example, in Patent Applications WO 2006/125532, WO 2006/125533 and WO 2006/125534.

In the rubber compositions in accordance with the invention, the content of coupling agent is preferably between 4 and 12 phr, more preferably between 4 and 8 phr.

A person skilled in the art will understand that, as filler equivalent to the reinforcing inorganic filler described in the present section, use might be made of a reinforcing filler of another nature, in particular organic nature, provided that this reinforcing filler is covered with an inorganic layer, such as silica, or else comprises functional sites, in particular hydroxyl sites, at its surface which require the use of a coupling agent in order to form the bond between the filler and the elastomer.

II.3. Crosslinking System

The epoxidized diene elastomer and the reinforcing filler described above are combined with a crosslinking system capable of crosslinking it or curing the composition of the tyre according to the invention. This crosslinking system comprises a (that is to say, at least one) polycarboxylic acid of general formula (I) and an (that is to say, at least one) imidazole of general formula (II).
II.3.a. Polyacid

The polyacid of use for the requirements of the invention is a polycarboxylic acid of general formula (I):

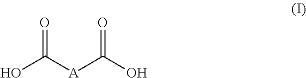

in which A represents a covalent bond or a hydrocarbon group which comprises at least 1 carbon atom, which is optionally substituted and which is optionally interrupted by one or more heteroatoms.

Preferably, in the polyacid of general formula (I), A represents a covalent bond or a divalent hydrocarbon group comprising from 1 to 1800 carbon atoms, preferably from 2 to 300 carbon atoms, more preferably from 2 to 100 carbon atoms and very preferably from 2 to 50 carbon atoms. Above 1800 carbon atoms, the polyacid is a less effective crosslinking agent. Thus, A preferably represents a divalent hydrocarbon group comprising from 3 to 50 carbon atoms, preferably from 5 to 50 carbon atoms, more preferably from 8 to 50 carbon atoms and more preferably still from 10 to 40 carbon atoms.

Preferably, in the polyacid of general formula (I), A can be a divalent group of aliphatic or aromatic type or a group comprising at least an aliphatic portion and an aromatic portion. Preferably, A can be a divalent group of aliphatic type or a group comprising at least an aliphatic portion and an aromatic portion. Alternatively and preferably again, A can be a divalent group of saturated or unsaturated aliphatic type, for example an alkylene group.

The A group of the polyacid of general formula (I) can be interrupted by at least one heteroatom chosen from oxygen, nitrogen and sulphur, preferably oxygen.

Also, the A group of the polyacid of general formula (I) can be substituted by at least one radical chosen from alkyl, cycloalkylalkyl, aryl, aralkyl, hydroxyl, alkoxy, amino and carbonyl radicals.

The polyacid of general formula (I) can comprise more than two carboxylic acid functional groups; in this case, the A group is substituted by one or more carboxylic acid functional groups and/or by one or more hydrocarbon radicals chosen from alkyl, cycloalkyl, cycloalkylalkyl, aryl or aralkyl radicals, themselves substituted by one or more carboxylic acid functional groups.

According to a preferred form, the A radical does not comprise another carboxylic acid functional group; the polyacid is thus a diacid.

The content of polyacid is preferably within a range extending from 0.2 to 100 phr, preferably from 0.2 to 50 phr, more preferably from 0.4 to 27 phr and more preferably still from 0.9 to 20 phr. Below 0.2 phr of polyacid, the effect of the crosslinking is not substantial, whereas beyond 100 phr of polyacid, the polyacid, crosslinking agent, becomes predominant by weight, with respect to the elastomeric matrix.

The polyacids of use for the requirements of the invention are either commercially available or are easily prepared by a person skilled in the art according to well-known techniques, such as chemical routes, described, for example, in the document U.S. Pat. No. 7,534,917 and also in the references cited in this document, or biological routes, such as the fermentation described in the document U.S. Pat. No. 3,843,466.

For example, mention may be made, as polyacids which are commercially available and which are of use for the requirements of the invention, of: oxalic acid, succinic acid, adipic acid, sebacic acid, dodecanedioic acid, terephthalic acid or also polyacids such as trimesic acid or 3,4-bis(carboxymethyl)cyclopentanecarboxylic acid.

II.3.b. Imidazole

The imidazole of use in the crosslinking system of the tyre of the invention is an imidazole of general formula (II):

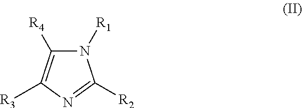

in which:

R₁ represents a hydrocarbon group or a hydrogen atom,

R₂ represents a hydrocarbon group,

R₃ and R₄ represent, independently of one another, a hydrogen atom or a hydrocarbon group,

or else R₃ and R₄ form, together with the carbon atoms of the imidazole ring to which they are attached, a ring.

Preferably, the imidazole of general formula (II) has groups such that:

R₁ represents a hydrogen atom or an alkyl group having from 1 to 20 carbon atoms, a cycloalkyl group having from 5 to 24 carbon atoms, an aryl group having from 6 to 30 carbon atoms or an aralkyl group having from 7 to 25 carbon atoms, which group can optionally be interrupted by one or more heteroatoms and/or substituted,

R₂ represents an alkyl group having from 1 to 20 carbon atoms, a cycloalkyl group having from 5 to 24 carbon atoms, an aryl group having from 6 to 30 carbon atoms or an aralkyl group having from 7 to 25 carbon atoms, which group can optionally be interrupted by one or more heteroatoms and/or substituted,

R₃ and R₄ independently represent identical or different groups chosen from hydrogen or alkyl groups having from 1 to 20 carbon atoms, cycloalkyl groups having from 5 to 24 carbon atoms, aryl groups having from 6 to 30 carbon atoms or aralkyl groups having from 7 to 25 carbon atoms, which groups can optionally be interrupted by heteroatoms and/or substituted, or else R₃ and R₄ form, together with the carbon atoms of the imidazole ring to which they are attached, a ring chosen from aromatic, heteroaromatic or aliphatic rings comprising from 5 to 12 carbon atoms, preferably 5 or 6 carbon atoms.

Preferably, R₁ represents a group chosen from alkyl groups having from 2 to 12 carbon atoms or aralkyl groups having from 7 to 13 carbon atoms, which groups can optionally be substituted. More preferably, R₁ represents an optionally substituted aralkyl group having from 7 to 13 carbon atoms and R₂ represents an alkyl group having from 1 to 12 carbon atoms. More preferably still, R₁ represents an optionally substituted aralkyl group having from 7 to 9 carbon atoms and R₂ represents an alkyl group having from 1 to 4 carbon atoms.

Preferably, R₃ and R₄ independently represent identical or different groups chosen from hydrogen or alkyl groups having from 1 to 12 carbon atoms, cycloalkyl groups having from 5 to 8 carbon atoms, aryl groups having from 6 to 24 carbon atoms or aralkyl groups having from 7 to 13 carbon atoms, which groups can optionally be substituted. Alternatively and preferably again, R₃ and R₄ form, with the carbon atoms of the imidazole ring to which they are attached, a benzene, cyclohexene or cyclopentene ring.

For good operation of the invention, the imidazole content is preferably within a range extending from 0.5 to 4 molar equivalents and preferably from 0.5 to 3 molar equivalents, with respect to the carboxylic acid functional groups present on the polycarboxylic acid of general formula (I). Below 0.5 molar equivalent, no effect of the imidazole coagent is observed in comparison with the situation where the polyacid is used alone, whereas, above a value of 4 molar equivalents, no additional benefit is observed in comparison with lower contents. Thus, the imidazole content is more preferably within a range extending from 0.5 to 2.5 molar equivalents, preferably from 0.5 to 2 molar equivalents and more preferably still from 0.5 to 1.5 molar equivalents, with respect to the carboxylic acid functional groups present on the polycarboxylic acid of general formula (I).

The imidazoles of use for the requirements of the invention are either commercially available or are easily prepared by a person skilled in the art according to well-known techniques, such as described, for example, in the documents JP2012211122 and JP2007269658 or also in Science of Synthesis, 2002, 12, 325-528.

For example, mention may be made, as imidazoles which are commercially available and which are of use for the requirements of the invention, of 1,2-dimethylimidazole, 1-decyl-2-methylimidazole or 1-benzyl-2-methylimidazole.

II.3.c. Polyacid and Imidazole

Obviously and in accordance with the definition of the expression “based on” for the present invention, a composition based on the polyacid of general formula (I) and on the imidazole of general formula (II) which are presented above might be a composition in which the said polyacid and the said imidazole have reacted together beforehand to form a salt between one or more acid functional groups of the polyacid and respectively one or more imidazole nuclei.

II.4. Various Additives

The rubber compositions of the tyres in accordance with the invention can also comprise all or a portion of the usual additives generally used in elastomer compositions intended for the manufacture of treads, such as, for example, pigments, protection agents, such as antiozone waxes, chemical antiozonants or antioxidants, antifatigue agents, crosslinking agents other than those mentioned above, reinforcing resins or plasticizing agents. Preferably, this plasticizing agent is a solid hydrocarbon resin (or plasticizing resin), an extending oil (or plasticizing oil) or a mixture of the two.

These compositions can also comprise, in addition to the coupling agents, coupling activators, agents for covering the inorganic fillers or more generally processing aids capable, in a known way, by virtue of an improvement in the dispersion of the filler in the rubber matrix and of a lowering of the viscosity of the compositions, of improving their ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

Preferably, the compositions of the tyres of the invention are devoid of a crosslinking system other than that described above and which comprises at least one polyacid and at least one imidazole. In other words, the crosslinking system based on at least one polyacid and at least one imidazole is preferably the only crosslinking system in the composition of the tyre of the invention. Preferably, the compositions of the tyres of the invention are devoid of a vulcanization system or comprise less than 1 phr, preferably less than 0.5 phr and more preferably less than 0.2 phr thereof. Thus, the composition of the tyre according to the invention is preferably devoid of molecular sulphur or comprises less than 1 phr, preferably less than 0.5 phr and more preferably less than 0.2 phr thereof. Likewise, the composition is preferably devoid of any vulcanization accelerator as known to a person skilled in the art or comprises less than 1 phr, preferably less than 0.5 phr and more preferably less than 0.2 phr thereof.

II.5. Preparation of the Rubber Compositions

The compositions used in the tyres of the invention can be manufactured in appropriate mixers, using two successive phases of preparation well known to a person skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) down to a lower temperature, typically of less than 110° C., for example between 40° C. and 100° C., during which finishing phase the crosslinking system can be incorporated.

Preferably, for the implementation of the invention, all the constituents of the composition are introduced into the internal mixer, so that the incorporation of a vulcanization system during the “productive” phase above can be dispensed with. This is because the crosslinking system of the compositions of the invention makes it possible to work the mixture at high temperature, which constitutes a major advantage during the preparation of the compositions of the invention, in comparison with the preparation of the compositions comprising a conventional vulcanization system.

The final composition thus obtained can subsequently be calendered, for example in the form of a sheet or of a plaque, in particular for laboratory characterization, or also extruded, for example in order to form a rubber profiled element used in the manufacture of the tyre of the invention.

II.6. Tyre of the Invention

The rubber composition of the tyre according to the invention can be used in different parts of the said tyre, in particular in the crown, the area of the bead, the area of the sidewall and the tread (in particular in the underlayer of the tread).

According to a preferred embodiment of the invention, the rubber composition described above can be used in the tyre as an elastomer layer in at least one part of the tyre.

Elastomer “layer” is understood to mean any three-dimensional component, made of rubber (or “elastomer”, the two being regarded as synonyms) composition, having any shape and thickness, in particular sheet, strip or other component having any cross-section, for example rectangular or triangular.

First of all, the elastomer layer can be used as tread underlayer positioned in the crown of the tyre between, on the one hand, the tread, i.e. the portion intended to come into contact with the road during running, and, on the other hand, the belt reinforcing the said crown. The thickness of this elastomer layer is preferably within a range extending from 0.5 to 10 mm, in particular within a range from 1 to 5 mm.

According to another preferred embodiment of the invention, the rubber composition according to the invention can be used to form an elastomer layer positioned in the region of the area of the bead of the tyre, radially between the carcass ply, the bead wire and the turn-up of the carcass ply.

Equally, the composition according to the invention can be used in the plies of the crown (tyre belt) or in the area between the ends of the plies of the crown and the carcass ply.

Another preferred embodiment of the invention can be the use of the composition according to the invention to form an elastomer layer positioned in the area of the sidewall of the tyre.

Alternatively, the composition of the invention can advantageously be used in the tread of the tyre.

III. EXAMPLES OF THE IMPLEMENTATION OF THE INVENTION

III.1. Preparation of the Compositions

The following tests are carried out in the following way: the epoxidized diene elastomer, the reinforcing filler, the polyacid, the imidazole and the other additives are successively introduced into an internal mixer (final degree of filling: approximately 70% by volume), the initial vessel temperature of which is approximately 60° C. Thermomechanical working (non-productive phase) is then carried out in one stage, which lasts in total approximately from 3 to 4 min, until a maximum “dropping” temperature of 180° C. is reached.

The mixture thus obtained is recovered and cooled, and the compositions thus obtained are subsequently calendered, either in the form of plaques (thickness from 2 to 3 mm) or of thin sheets of rubber, for the measurement of their physical or mechanical properties, or extruded in the form of a profiled element.

III.2. Tests on Rubber Compositions

This test illustrates rubber compositions which can be used in particular as tread of the tyre of the invention. These compositions are easier to prepare and simpler than a conventional rubber composition (vulcanized with sulphur), while also improving the hysteresis of the compositions in comparison with the compositions vulcanized with sulphur.

For this, rubber compositions were prepared as indicated above, some of which in accordance with the invention (C3 and C4) and some of which not in accordance (controls Cl and C2), as shown in Table 1.

Compositions C1 and C2 are vulcanized compositions (that is to say, crosslinked by a sulphur-based vulcanization system conventional for the curing of tyres) whereas compositions C3 and C4 are compositions crosslinked by a polyacid and an imidazole according to the invention.

The properties of the compositions C1 to C4 were measured as indicated above and the results are shown in Table 2.

A greater simplicity of the mixture is noted in the compositions of the invention, with fewer ingredients than in the control compositions. Furthermore, it may be noted that the replacement of the conventional vulcanization system by a polyacid and imidazole crosslinking system as prescribed for the invention makes it possible to obtain an improvement in the hysteresis of the mixture, with a stiffness/elongation at break compromise similar to the vulcanized control.

TABLE 1

| | C1 | C2 | C3 | C4 |
|---|---|---|---|---|
| ENR25 (1) | 100 | 100 | 100 | 100 |
| Carbon black (2) | 54 | | 54 | — |
| Silica (3) | — | 45 | — | 45 |
| Silane (4) | — | 4.5 | — | 4.5 |
| 6PPD (5) | 3 | 3 | 3 | 3 |
| Polyacid (6) | — | — | 1.1 | 1.1 |
| Imidazole (7) | — | — | 1.65 | 1.65 |
| Sulphur | 1.2 | 1.3 | — | — |
| Accelerator (8) | 1.2 | 1.56 | — | — |
| ZnO (9) | 3 | 2.7 | — | — |
| Stearic acid (10) | 1.5 | 2.5 | — | — |

(1) Epoxidized Natural Rubber, “ENR-25”, from Guthrie Polymer;
(2) Carbon black N234 (name according to Standard ASTM D-1765);
(3) Silica 160 MP (Zeosil 1165MP from Rhodia);
(4) Dynasylan Octeo from Degussa;
(5) N-(1,3-Dimethylbutyl)-N-phenyl-para-phenylenediamine (Santoflex 6-PPD from Flexsys);
(6) Dodecanedioic acid, CAS 693-23-2, from Sigma-Aldrich;
(7) 1-Benzyl-2-methylimidazole, CAS = 13750-62-4 from Sigma-Aldrich;
(8) N-Cyclohexyl-2-benzothiazolesulphenamide (Santocure CBS from Flexsys);
(9) Zinc oxide (industrial grade, Umicore);
(10) Stearin (Pristerene 4931 from Uniqema).

TABLE 2

| | C1 | C2 | C3 | C4 |
|---|---|---|---|---|
| MSA50 (MPa) | 3.38 | 2.24 | 2.78 | 2.45 |
| MSA100 (MPa) | 2.95 | 1.96 | 2.50 | 2.14 |
| Elongation at break (%) | 333 | 445 | 357 | 480 |
| tanδₘₐₓ 23° C. return | 0.408 | 0.224 | 0.362 | 0.210 |

1.-28. (canceled)

29. A tire comprising a rubber composition comprising:
at least one predominant diene elastomer comprising epoxide functional groups;
at least one reinforcing filler; and
a crosslinking system comprising
a polycarboxylic acid of general formula (I): 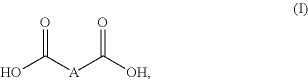
wherein A is a covalent bond or a hydrocarbon group which comprises at least one carbon atom, which is optionally substituted and which is optionally interrupted by one or more heteroatoms, and
an imidazole of general formula (II): 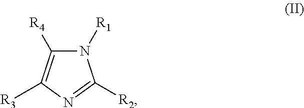
wherein R₁ is a hydrocarbon group or a hydrogen atom,
wherein R₂ is a hydrocarbon group, and
wherein R₃ and R₄ are, independently of one another, a hydrogen atom or a hydrocarbon group, or R₃ and R₄ form, together with the carbon atoms of the imidazole ring to which they are attached, a ring.

30. The tire comprising a rubber composition according to claim 29, wherein A is a covalent bond or a divalent hydrocarbon group comprising from 1 to 1800 carbon atoms.

31. The tire comprising a rubber composition according to claim 30, wherein the divalent hydrocarbon group comprises from 2 to 300 carbon atoms.

32. The tire comprising a rubber composition according to claim 29, wherein A is a divalent hydrocarbon group comprising from 2 to 100 carbon atoms.

33. The tire comprising a rubber composition according to claim 32, wherein the divalent hydrocarbon group comprises from 2 to 50 carbon atoms.

34. The tire comprising a rubber composition according to claim 29, wherein A is a divalent hydrocarbon group comprising from 3 to 50 carbon atoms.

35. The tire comprising a rubber composition according to claim 34, wherein the divalent hydrocarbon group comprises from 5 to 50 carbon atoms.

36. The tire comprising a rubber composition according to claim 29, wherein A is a divalent hydrocarbon group comprising from 8 to 50 carbon atoms.

37. The tire comprising a rubber composition according to claim 36, wherein the divalent hydrocarbon group comprises from 10 to 40 carbon atoms.

38. The tire comprising a rubber composition according to claim 29, wherein A is a divalent group of aliphatic or aromatic type or a group comprising at least an aliphatic portion and an aromatic portion.

39. The tire comprising a rubber composition according to claim 29, wherein A is a divalent group of aliphatic type or a group comprising at least an aliphatic portion and an aromatic portion.

40. The tire comprising a rubber composition according to claim 29, wherein A is a divalent group of saturated or unsaturated aliphatic type.

41. The tire comprising a rubber composition according to claim 29, wherein A is an alkylene group.

42. The tire comprising a rubber composition according to claim 29, wherein A is interrupted by at least one heteroatom selected from the group consisting of oxygen, nitrogen and sulphur.

43. The tire comprising a rubber composition according to claim 42, wherein A is interrupted by oxygen.

44. The tire comprising a rubber composition according to claim 29, wherein A is substituted by at least one radical selected from the group consisting of alkyl, cycloalkylalkyl, aryl, aralkyl, hydroxyl, alkoxy, amino and carbonyl radicals.

45. The tire comprising a rubber composition according to claim 29, wherein A is substituted by one or more carboxylic acid functional groups, by one or more hydrocarbon radicals selected from the group consisting of alkyl, cycloalkyl, cycloalkylalkyl, aryl and aralkyl radicals, themselves substituted by one or more carboxylic acid functional groups, or by one or more carboxylic acid functional groups and by one or more hydrocarbon radicals selected from the group consisting of alkyl, cycloalkyl, cycloalkylalkyl, aryl and aralkyl radicals, themselves substituted by one or more carboxylic acid functional groups.

46. The tire comprising a rubber composition according to claim 29, wherein A does not comprise another carboxylic acid functional group.

47. The tire comprising a rubber composition according to claim 29, wherein a content of the polycarboxylic acid of general formula (I) is within a range extending from 0.2 to 100 phr.

48. The tire comprising a rubber composition according to claim 47, wherein the content is within a range extending from 0.2 to 50 phr.

49. The tire comprising a rubber composition according to claim 29, wherein a content of the polycarboxylic acid of general formula (I) is within a range extending from 0.4 to 27 phr.

50. The tire comprising a rubber composition according to claim 49, wherein the content is within a range extending from 0.9 to 20 phr.

51. The tire comprising a rubber composition according to claim 29, wherein R₁ is selected from the group consisting of a hydrogen atom, an alkyl group having from 1 to 20 carbon atoms, a cycloalkyl group having from 5 to 24 carbon atoms, an aryl group having from 6 to 30 carbon atoms and an aralkyl group having from 7 to 25 carbon atoms, which groups can optionally be interrupted by one or more heteroatoms and/or substituted,
wherein R₂ is selected from the group consisting of an alkyl group having from 1 to 20 carbon atoms, a cycloalkyl group having from 5 to 24 carbon atoms, an aryl group having from 6 to 30 carbon atoms and an aralkyl group having from 7 to 25 carbon atoms, which groups can optionally be interrupted by one or more heteroatoms and/or substituted, and
wherein R₃ and R₄ independently are selected from the group consisting of hydrogen, alkyl groups having from 1 to 20 carbon atoms, cycloalkyl groups having from 5 to 24 carbon atoms, aryl groups having from 6 to 30 carbon atoms or aralkyl groups having from 7 to 25 carbon atoms, which groups can optionally be interrupted by heteroatoms and/or substituted, or R₃ and R₄ form, together with the carbon atoms of the imidazole ring to which they are attached, a ring chosen from aromatic, heteroaromatic or aliphatic rings comprising from 5 to 12 carbon atoms.

52. The tire comprising a rubber composition according to claim 29, wherein R₁ is selected from the group consisting of alkyl groups having from 2 to 12 carbon atoms and aralkyl groups having from 7 to 13 carbon atoms, which groups can optionally be substituted.

53. The tire comprising a rubber composition according to claim 29, wherein R₁ is an optionally substituted aralkyl group having from 7 to 13 carbon atoms, and
wherein R₂ is an alkyl group having from 1 to 12 carbon atoms.

54. The tire comprising a rubber composition according to claim 29, wherein R₁ is an optionally substituted aralkyl group having from 7 to 9 carbon, and
wherein R₂ is an alkyl group having from 1 to 4 carbon atoms.

55. The tire comprising a rubber composition according to claim 29, wherein R₃ and R₄ independently are selected from the group consisting of hydrogen, alkyl groups having from 1 to 12 carbon atoms, cycloalkyl groups having from 5 to 8 carbon atoms, aryl groups having from 6 to 24 carbon atoms or aralkyl groups having from 7 to 13 carbon atoms, which groups can optionally be substituted.

56. The tire comprising a rubber composition according to claim 29, wherein R₃ and R₄ form, with the carbon atoms of the imidazole ring to which they are attached, a benzene, cyclohexene or cyclopentene ring.

57. The tire comprising a rubber composition according to claim 29, wherein an imidazole content is within a range extending from 0.5 to 4 molar equivalents with respect to the carboxylic acid functional groups present on the polycarboxylic acid of general formula (I).

58. The tire comprising a rubber composition according to claim 57, wherein the imidazole content is within a range extending from 0.5 to 3 molar equivalents with respect to the carboxylic acid functional groups present on the polycarboxylic acid of general formula (I).

59. The tire comprising a rubber composition according to claim 29, wherein an imidazole content is within a range extending from 0.5 to 2.5 molar equivalents with respect to the carboxylic acid functional groups present on the polycarboxylic acid of general formula (I).

60. The tire comprising a rubber composition according to claim 59, wherein the imidazole content is within a range extending from 0.5 to 2 molar equivalents with respect to the carboxylic acid functional groups present on the polycarboxylic acid of general formula (I).

61. The tire comprising a rubber composition according to claim 60, wherein the imidazole content is within a range extending from 0.5 to 1.5 molar equivalents with respect to the carboxylic acid functional groups present on the polycarboxylic acid of general formula (I).

62. The tire comprising a rubber composition according to claim 29, wherein the predominant diene elastomer comprising epoxide functional groups is an epoxidized diene elastomer selected from the group consisting of epoxidized natural rubbers, epoxidized synthetic polyisoprenes, and mixtures thereof.

63. The tire comprising a rubber composition according to claim 29, wherein the predominant diene elastomer comprising epoxide functional groups represents from 30 to 100 phr, as a blend with from 0 to 70 phr of one or more minor non-epoxidized elastomers.

64. The tire comprising a rubber composition according to claim 63, wherein the predominant diene elastomer represents from 50 to 100 phr, as a blend with from 0 to 50 phr of one or more minor non-epoxidized elastomers.

65. The tire comprising a rubber composition according to claim 29, wherein the predominant diene elastomer comprising epoxide functional groups represents all of the 100 phr of elastomer.

66. The tire comprising a rubber composition according to claim 29, wherein the reinforcing filler comprises carbon black, silica or a mixture of carbon black and silica.

67. The tire comprising a rubber composition according to claim 29, wherein a content of reinforcing filler is between 20 and 200 phr.
